(19) United States
(12) Patent Application Publication
(10) Pub. No.: US 2012/0254829 A1
(43) Pub. Date: Oct. 4, 2012

(54) METHOD AND SYSTEM TO PRODUCE SECURE SOFTWARE APPLICATIONS

(75) Inventors: Nishchal Bhalla, Toronto (CA); Rohit Kumar Sethi, Toronto (CA); Sahba Kazeroonizadeh, Toronto (CA); Ramanan Sivaranjan, Toronto (CA)

(73) Assignee: Infotek Solutions Inc. doing business as Security Compass, Shrewsbury, NJ (US)

(21) Appl. No.: 13/078,520

(22) Filed: Apr. 1, 2011

(51) Int. Cl. G06F 9/44

(52) U.S. Cl. 717/105; 717/100

(57) ABSTRACT

This invention relates to a method and system of providing security guidance in writing software applications. More particularly this invention relates to accessing guidance application linked to a computer and a data base of security features to present a user with suggestive security content in writing software applications. The invention also relates to a non-transitory computer program for use on the computer in writing the software applications.

### FIELD OF INVENTION

This invention relates to a method and system of providing security guidance in writing software applications. More particularly this invention relates to accessing guidance application linked to a computer and a data base of security features to present a user with suggestive security content in writing software applications. The invention also relates to a non-transitory computer program for use on the computer in writing the software applications.

### BACKGROUND TO THE INVENTION

Generally speaking software developments currently lack relevant, context specific tools to help them build secure software from the beginning. Currently the prior art offers tools to detect security vulnerabilities in source code and run time after the source code has been written. This presents a challenge since fixing a vulnerability after coding is costly and often difficult.

Moreover software developers generally do not have a centralized, reliable source to access for demonstrative secure source code in different programming languages and associated technologies such as web application frameworks. Often they rely on Internet sources that may not have undergone review from security experts.

Furthermore, requirements analysts are often not security experts, and therefore often miss opportunities to build security into the earliest part of the software development lifecycle. Requirements analysts do not currently have access to a tool that will give them tailored advice on which security requirements they should embed into their applications.

Also, Quality Assurance testers do not have access to custom tailored advice on how to imbed security testing into their applications and how to integrate it into their existing quality assurance tools. Quality Assurance testers are ideally positioned to catch security vulnerabilities before they are deployed into the production of software.

Software development teams generally speaking lack tools that allow them to provide tracking and accountability for performing software security activities. For example most project managers have no way of knowing if their developers have followed secure programming guidelines.

Moreover secure development standards often written in static documents are not updated when new technologies and vulnerabilities are written. These documents often become outdated within a short period of time.

For example, U.S. Pat. No. 7,865,732 relates to a method, system and computer readable medium for secure e-commerce communications, including an e-commerce system, including a private system for maintaining confidential information; and a public system for maintaining non-confidential information.

Furthermore, U.S. Pat. No. 7,865,383 relates to a system and method for examining, describing, analyzing and/or predicting an organization's emerging level of performance during routine, special and unexpected events. The tools include a methodology and process for systematically building, collecting and archiving profiles of the performance capacity with specific organizations or across wider industry or cultural groups.

Yet another method and system is disclosed in U.S. Pat. No. 7,865,958 which relates to end-user risk management which evaluates and responds to informational risks on a wide variety of computing platforms and in a rapidly changing network environment.

Yet another system is shown in U.S. Pat. No. 6,952,779 which relates to systems and methods for risk detection and analysis in a computer network. Computerized automated systems and methods can be provided. Raw vulnerability information and network information can be utilized in determining actual vulnerability information associated with network notes.

Finally the U.S. Publication 20090083695 teaches systems and methods relating to a method for generating a threat analysis and modelling tool. In an implementation, aggregate analysis is performed upon applications of an enterprise for complete risk management of the enterprise. The threat analysis model is generated by defining the application, its attributes and the rules relating to the application. An application task list is generated from a common task list for the application. Countermeasures for known attacks pertaining to the application are described in the application task list, which allows developers to reduce the risk of attacks.

The tool described in U.S. Publication 20090083695 is focused on threat modelling within the Software Development Life Cycle (the “SDLC”).

SDLC is a process of developing information systems through investigation, analysis, design, implementation and maintenance SDLC is a systems approach to problem solving and is made up of several phases each comprised of multiple steps. Threat modelling helps to build security into an application's design.

However, there is a need to build security into the requirements, design, development, testing and deployment phase of SDLC.

It is an object of this invention to provide a method and system that dispenses tailored application security guidance with a focus on preventing and detecting rather than solely detecting vulnerabilities.

Furthermore, it is an object of this invention to provide centralized guidance that is automatically generated and may be vetted by application security experts. There is a need to generate tailored, relevant security coding guidelines and code samples for a large variety of common programming languages, framework, platforms and other technologies.

Several different organizations have attempted to solve software security problems by providing detective's tools such as software static analysis and run-time testing applications. However, none of these tools provide specific technical guidance on avoiding writing insecure code in the first place.

Furthermore, other efforts have attempted to provide general accountability of security activities or have provided a large knowledge base of security advice, but do not offer specific technical guidance such as tailored secure coding guidelines.

It is an aspect of this invention to provide method of providing security guidance in writing software applications as well as a tool to help build security into every phase of the software development life cycle. Requirements analysts, designers, developers, and testers can use the tool to get tailored guidance relevant to their application and their role. Most application security focus on source code and at run time. An embodiment of this invention focuses on every phase even before designing code to minimize or even prevent security breaches at every phase as to reduce the cost of application security. In other words to minimize security vulnerabilities even before they are coded.

It is another aspect of this invention to provide a non-transitory computer program for use on a computer, the non-transitory computer product comprising: a computer usable medium; and computer readable program code recorded or storable in the computer usable medium, the computer readable program code defining a guidance application that is operable to: present to a user a suggestive modeling interface, the suggestive modeling interface operable to assist a user in producing software applications based on at least one of the following: writing software application input from the user; one or more aspects of one or more suggestive security content obtained from a database; utilizing a matching operator linked to the suggestive modeling interface to dynamically and iteratively provide access to one or more security features from the database to permit the user to write software applications in a more secure manner.

It is yet another aspect of the invention to provide a system for collecting data from a user's electronic device via the Internet to generate security guidance to the user in writing software applications comprising: a web server connected to the Internet, the web server including a processor and a memory operatively connected to the processor; a web application loaded on the web server; a database of security features; a database management utility linked to the database and responsive to the web application; whereby the web application: i) permits an authorized user to link to the web application through said electronic device; ii) enters data relating to building the user software application; iii) automatically generating suggestive security features stored in the database in response to the data relating to building the users software application.

These and other objects and features of the invention shall now be described in relation to the following drawings.

### BRIEF DESCRIPTION OF THE DRAWINGS

FIG. 1 is a schematic drawing illustrating one embodiment of the system.

FIG. 2 is a flowchart on creating a project.

FIGS. 2a and 2b illustrate dashboards implementing the flow chart of FIG. 2.

FIG. 3 is a flowchart relating to work on phases of SDLC.

FIG. 4 illustrates a flowchart for a typical SDLC.

FIG. 5 is a flowchart enclosing the project.

FIG. 6 provides a sample of a dashboard illustrating a guide for software design.

FIGS. 7a and 7b illustrates dashboards to generate guides.

FIGS. 8a and 8b illustrate Implementation guidelines and positive code examples, is a project dashboard.

FIG. 9 illustrates test authentication.

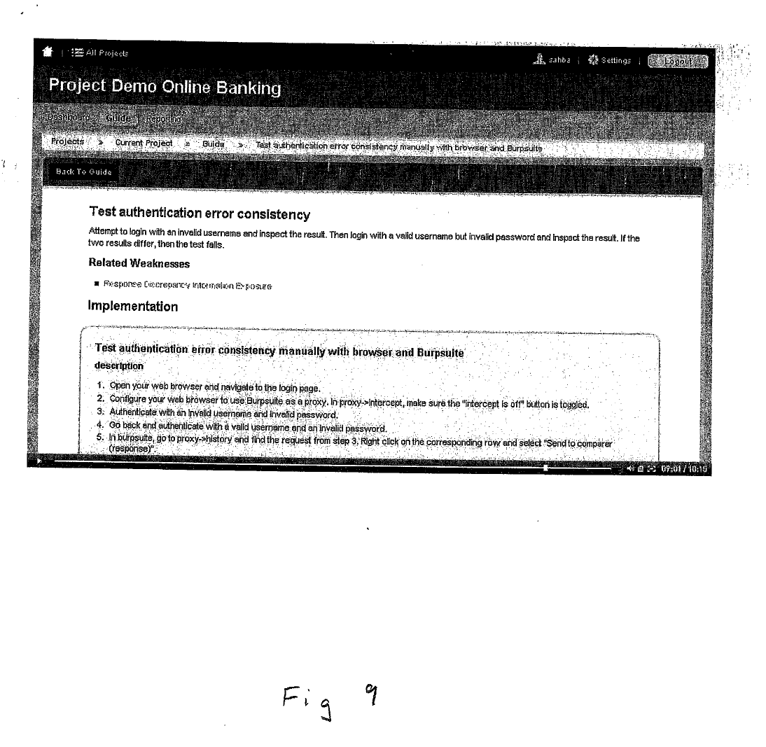

FIG. 10 illustrates a dashboard in compliance.

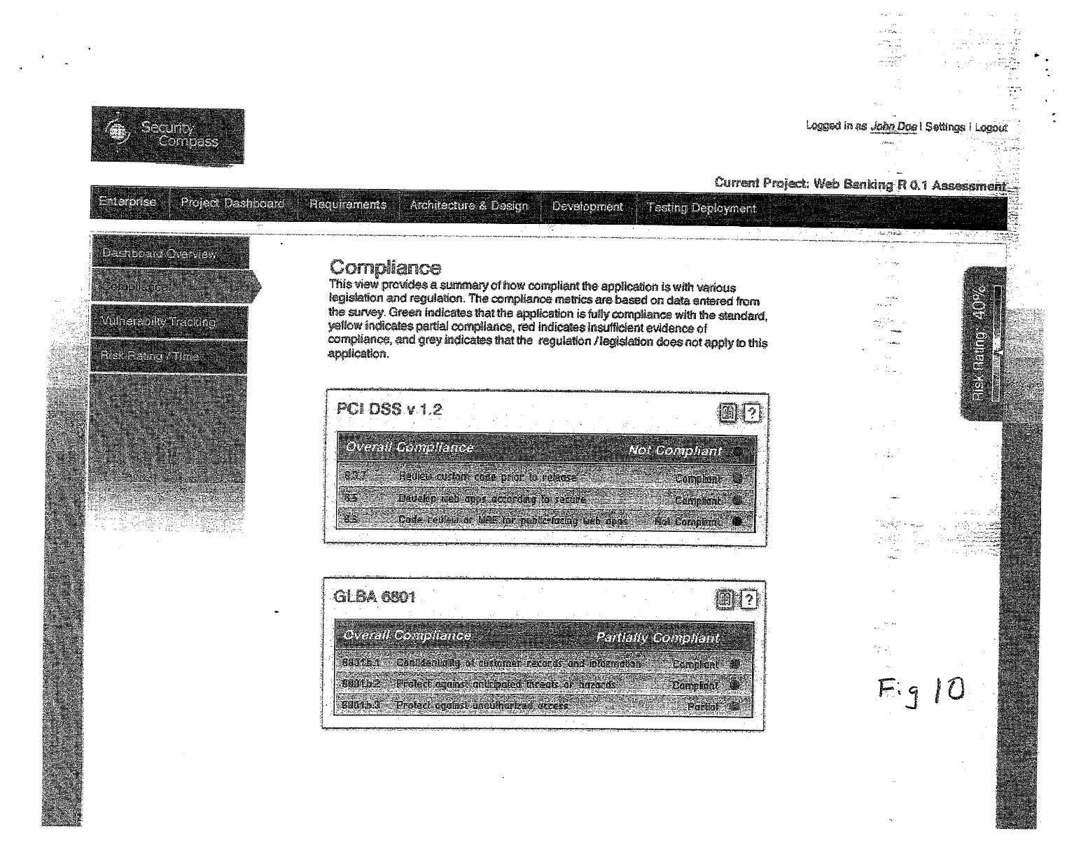

FIG. 11 is a dashboard relating to risk ratings.

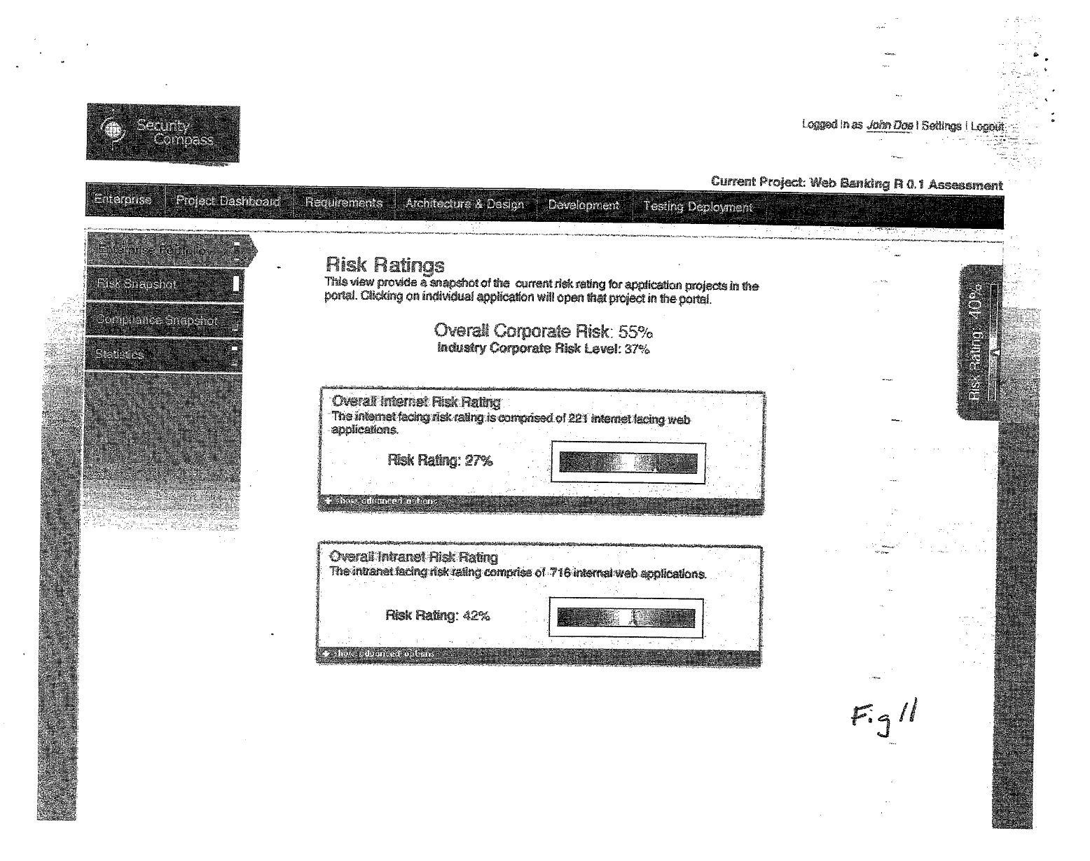

FIG. 12 is another embodiment of a dashboard relating to risk ratings.

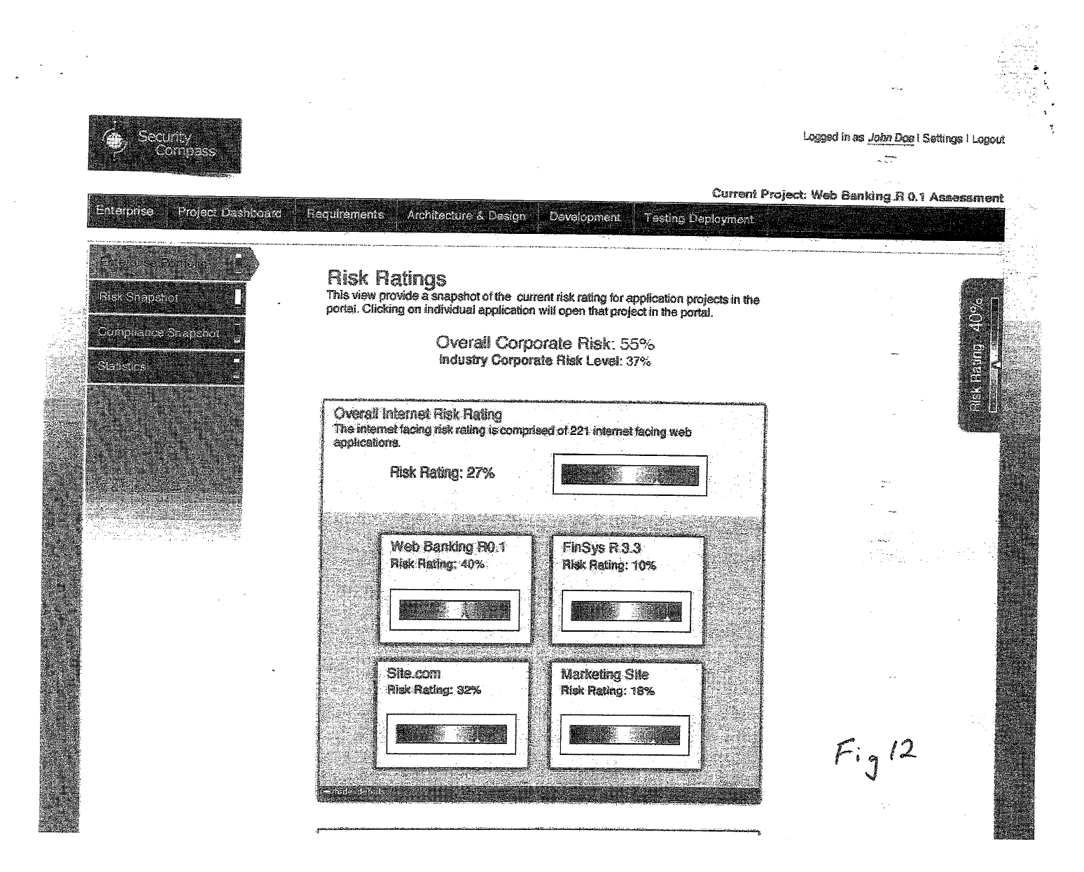

### DETAILED DESCRIPTION OF THE INVENTION

The invention to be described herein shows developers how to follow a quality controlled security guide. Currently developers only have access to large repositories of information that are not easy to navigate, are not tailored to their environment, not subject to commercial grade quality controls, and don't provide auditability about what tasks have been performed.

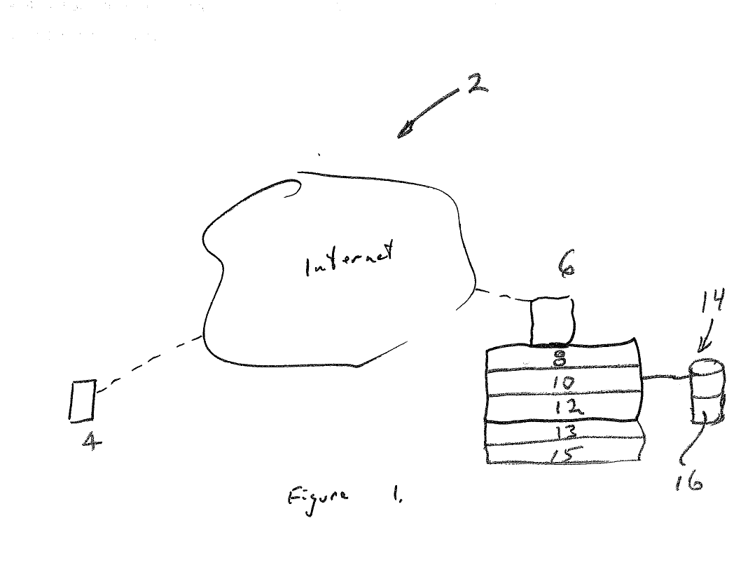

FIG. 1 illustrates an embodiment of the system for collecting data from a user's electronic device via the Internet to generate security guidance to a user in writing software applications by utilizing a computer or web server 6. The electronic device 4 may connect to the Internet through use of USB cable or wirelessly in a manner well-known to those persons skilled in the art.

Furthermore, a computer or web server 6 may also connect to the Internet in the same manner.

The system to be described herein may include a plurality of users connected to the Internet through a plurality of electronic devices 4. The electronic devices can comprise the user computers, PDAs, cell phone and the like.

A computer or web server 6 is connected to the Internet; and the web server 6 includes a processor 8, a memory 10 operatively connected to the processor 8 as well as a web application 12 located on the web server.

FIG. 1 also illustrates a data base 14 which includes information concerning security features. A data base management utility 16 is linked to the data base 14 and is responsive to the web application 12.

The web server 12 permits an authorized user to link to the web application 14 by means of the Internet and electronic device 4. The typical authorization occurs through user names and security codes in a manner well-known to those persons skilled in the art.

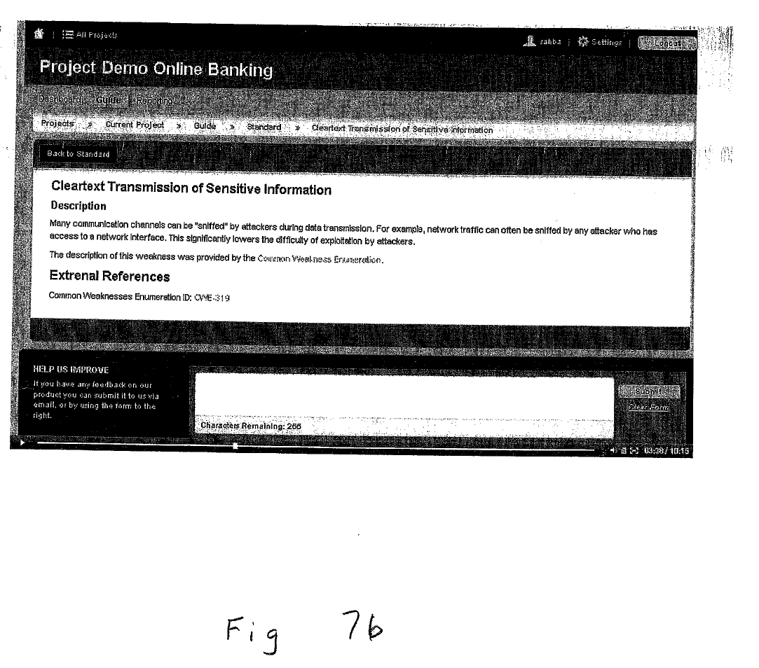

Once the user is linked to the web server 6 a dashboard appears, an example of which is shown in FIG. 6.

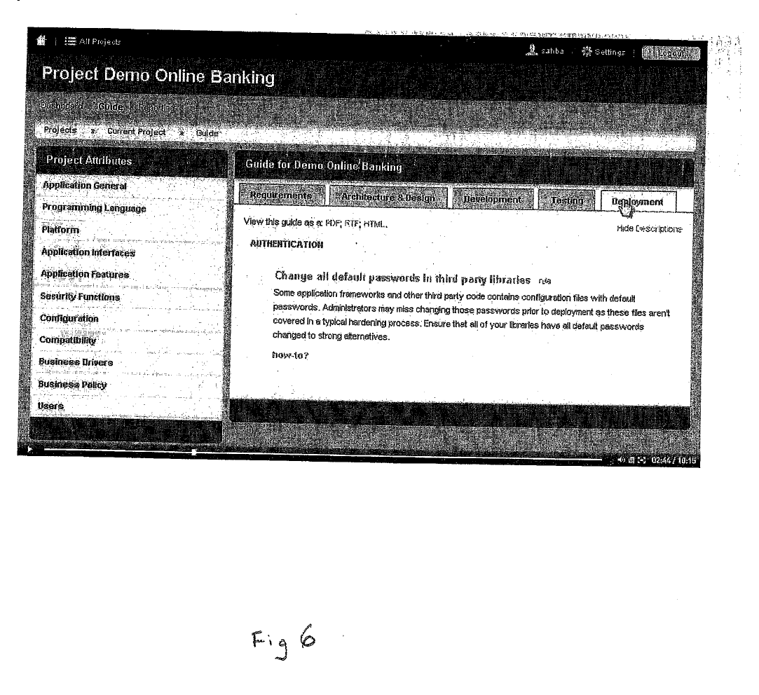

Typical phases for designing software applications are shown in FIG. 4 which relate to a software development life cycle flowchart. The SDLC includes creating the Project 20, the Requirements Phase 22, the Design Phase 24, the Development Phase 26, the Test Phase 28, the Deployment Phase 30 and the closing of the project phase 32.

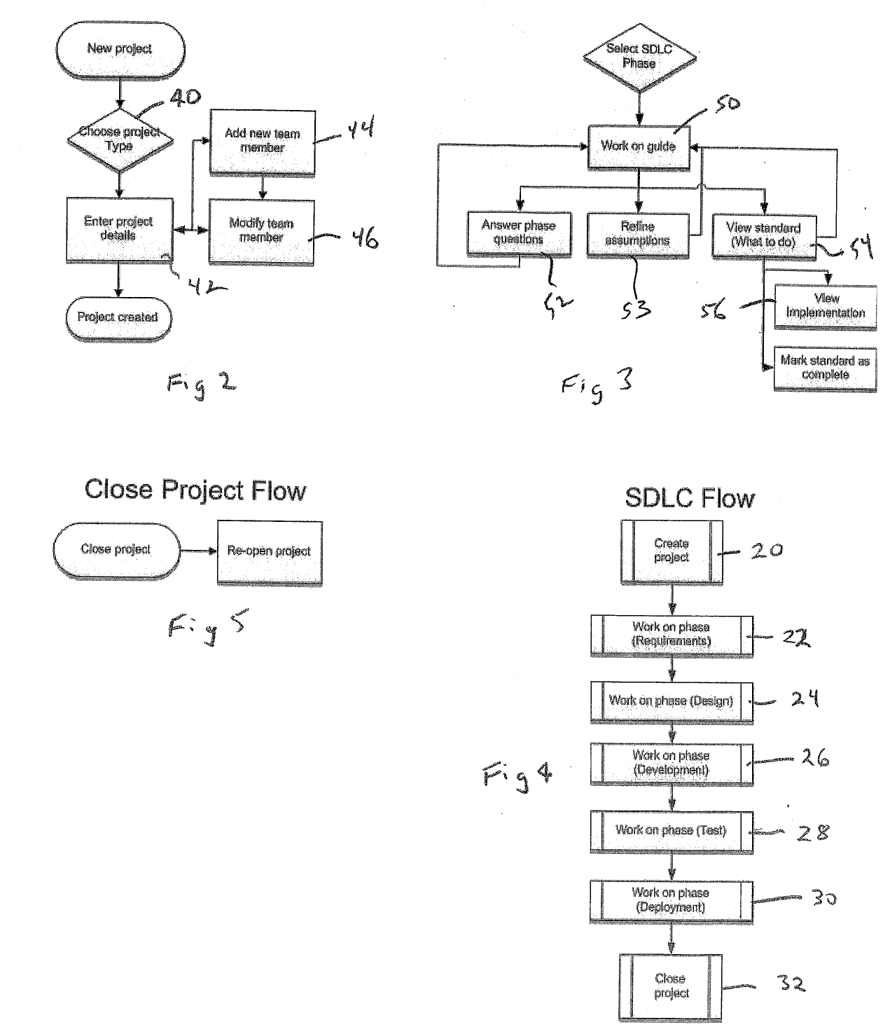

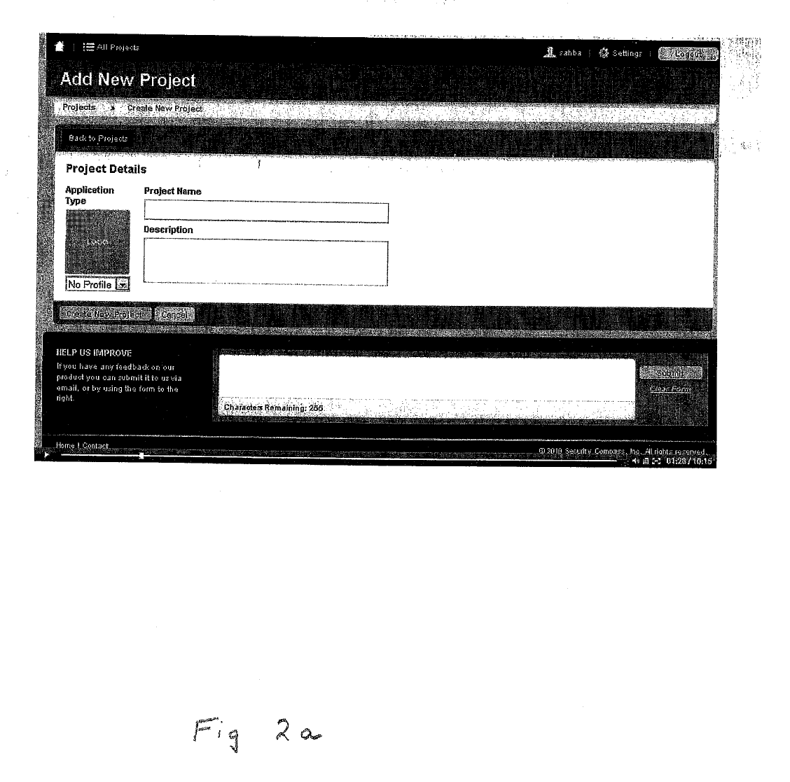

In creating a New Project as shown in FIG. 2 a Project Leader or Systems Administrator begins by creating a New Project for a current or upcoming Project, illustrated by the dashboard shown in FIG. 2a. Specifying a Project allows the system 2 to start tailoring advice right away. For example in the case shown a project name is given, “R20 Online Banking” and selecting Java EE profiles (from a list which includes Java, Classic, ASO, C, ASB.NET) for example as shown in FIG. 2b which comes with a set of prepopulated attributes best illustrated in FIG. 6.

The invention described herein provides guidance to different stakeholders in the Software Development Life Cycle. For example the project “R20 Online Banking” starts in the “Requirements View”. Requirements Analysts look at the security requirements for the project. Architects can view advice on the design of the application. If we move to the Developments view one can see secure coding standards. Testers are shown how to test against security requirements. There is security guidance to follow during security development all of which is illustrated in FIG. 6.

The dashboard will require a user to choose the project type 40 which can be any one of the phases 20, 22, 24, 26, 28, 30, 32 as shown in FIG. 4. For example the user will create a project 20 such as the Requirements Phase 22. The user will enter project details 42 where new team members 44 may be added or team members modified as shown in 46.

Guidance at each phase is broken into individual standards. Software development elements provide a super set of the Oops development guide and encompass all threads of the WASP threads classification. Other attacks against code are routinely assessed and incorporated to the guidance standards of the system 2.

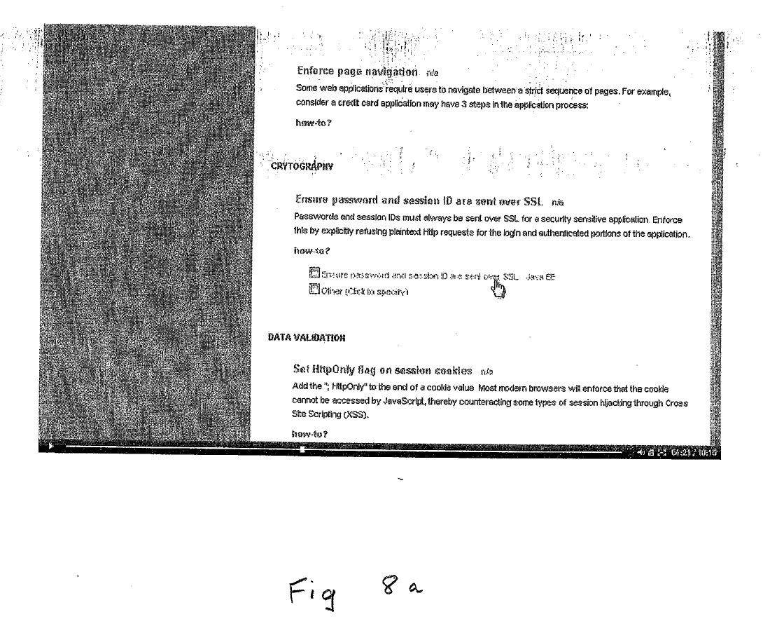

If one activates the guide button of FIGS. 7a and 7b guidance details are presented concerning program language diagnostics on coding standard. If one needs to know why we need to follow the standard one can click the weakness link to follow the software security flaw for this standard. When possible CWE weakness numbers are provided as illustrated in FIG. 7a.

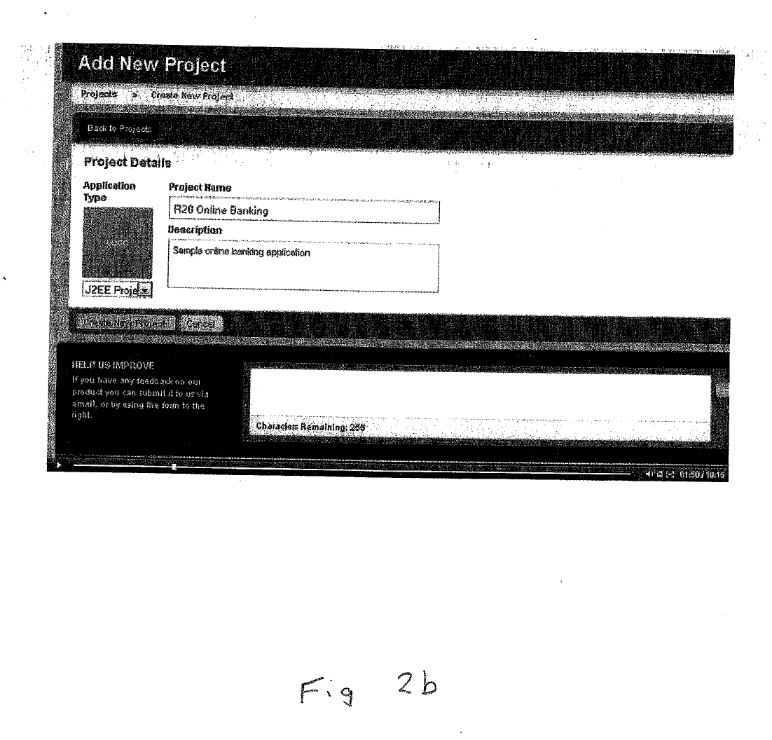

FIG. 3 illustrates the guidance application process whereby the user will answer questions in an answer phase 52 such as, for example, if the software will be in Java or other form. Furthermore, based on the input from the answer phase 52, the web application 12 will generate how to best design the software 54 in accordance with security rules stored in the data base 14.

For example, if the invention herein is to be used by financial institutions having credit card transactions, the data base 14 would include regulations and control frameworks such as the Payment Card Industry Data Security Standard (the “PCI DSS”), COBIT, ISO 27001 (formerly 17799), GLPA, and the like. In other words SD elements help achieve compliance requirements such as PCI DSS 6.5.

Furthermore, if the invention described herein is used in relation to the healthcare industry there are other requirements concerning the privacy of the healthcare industry that can be stored in the data base 14.

The data base 14 can include best practice rules concerning the design of software code to produce software applications as well as rules concerning security structures and procedures for communication on the Internet and for particular businesses.

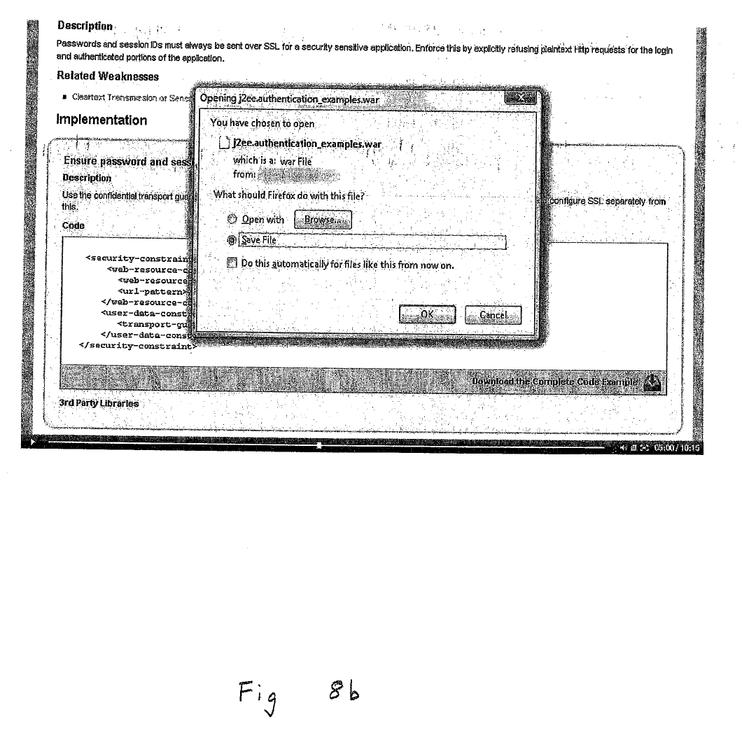

In one embodiment of the invention Implementation 56 in the flowchart is implemented by activating the “How To” link illustrated in FIG. 8a to follow each standard using relevant language, platform, and libraries. For example the project “Java EE” is in Java so the implementation details are in Java and don't waste time in other languages. Upon clicking the Implementation Description one will see a description and positive code examples as illustrated for example in FIG. 8b. Also as shown complete code examples may be imported or shown. In other words Developers can download the code examples and try or run them for themselves. One can import the example into an IDE such as Eclipse, view the complete code, and even the program to see the standard in action.

After the project is created by answering questions 52 called project attributes (see FIG. 6) one can fine tune 53 the list of guidance even further. One can provide as little or as much information as possible. The more detailed the information the more specific and dynamic the guidance. Changes in the attributes directly affects the list of standards. Attributes can be broken down into categories so as to concentrate answering questions in the area of expertise. For example Requirements Analysts will likely focus on questions relating to business and applications while Developers will focus on programming language and platform.

The attribute section allows communication between the stakeholders. For example if one required the SDL elements to know that STRUTS was being used in the application one could do that under the Platform Attribute group. By activating the STRUTS button one can look at the specific guidance specific to STRUTS that support STRUTS.

With respect to auditability one can check or uncheck the Development Standards to indicate that individual standards was followed; this provides traceability and allows software development lifecycle stakeholders to communicate their completion standard for each phase. Once a standard has been completed it is so designated by clicking a button. This gives project teams auditability as to which user has completed which actions.

In the Security Test Phase 28 the SDL runs routine test cases relevant to the particular application. Users can specify the testing suite, and the system provides guidance on how to test that particular suite. Embedded video illustrate the text descriptions and provide relevant detail as for example where to click.

FIG. 3 generally describes a system which automatically tailors working on the guide 50 to provide security guidance to a user to write more secure software code.

The invention described herein automatically and iteratively provides a guidance application which works on the guide 50 at each of the phases namely the Requirements Phase 22, the Design Phase 24, the Development Phase 26, the Test Phase 28 and the Deployment Phase 30 as shown in FIG. 4 in connection with the SDLC.

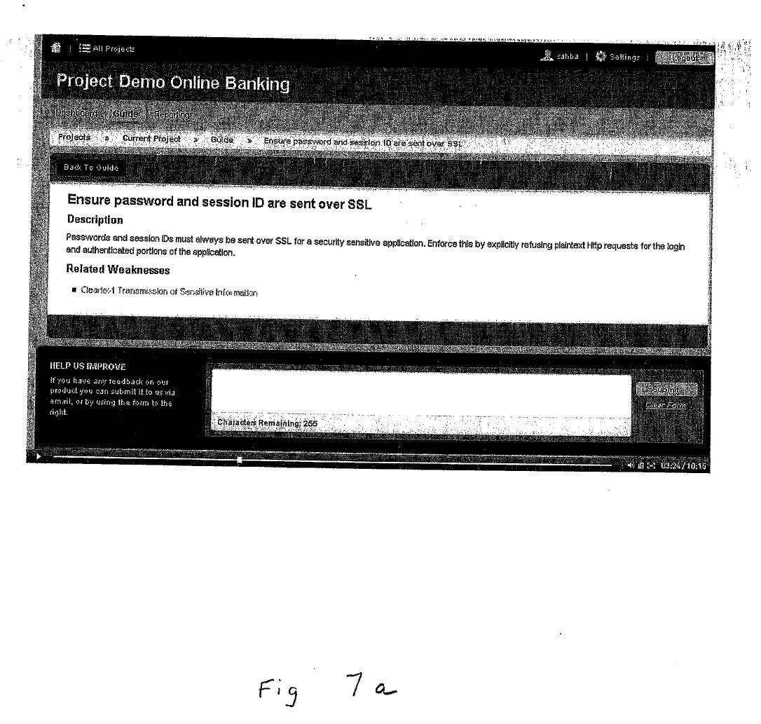

Once this is completed the project can be closed as substantially illustrated in FIG. 5.

The guidance application generates a series of suggestive instructions for guiding the user in writing more secure software code right from the beginning.

The invention described herein provides a system, method and tool which assists analysts by creating tailored security requirements and helps developers by providing secure coding guidelines and samples for developers to reference. Both of these assist in preventing rather than just detecting software security vulnerabilities.

The system described herein provides specific, tailored security advice and assists in tracking security activities through every phase of the Secure Development Life Cycle.

In one embodiment the web application described herein is written on the Django web application framework. The Django is based on the Python programming language and allows for rapid prototyping, thereby allowing one to integrate user feedback.

As with most Django applications, the tool is built on top of a Model Viewing Controller (“MVC”) framework. The “view” later is the user interface that allows end users to interact with the application. The model layer represents persistent objects, which are manipulated and translated to views by the controller layer. The data can reside with relational data base.

Moreover, the project properties relate to properties about a particular software project 40 that allows the system to tailor advice. For example, one property can be “application uses Java” and another might be “application must comply to Payment Card Industry Data Security Standards”. The properties can encapsulate both technical as well as business or process domains.

The system can include inclusion rules which relate to rules used in other parts of the system which can be composed of boolean operators and project properties. For example, the application uses Java AND application is web-based.

The system also has questions and answers where questions are asked of users to gain an understanding of the system. Answers to questions grant project properties where questions can include inclusion rules so that the system only asks relevant questions (for example, only ask what version of Java you are using after you specify that you have indeed been using Java).

The system also includes surveys which are a set of logical related questions and answers. For example, a development survey will contain questions relevant to the development phase of the Software Development Life Cycle.

The system also includes weaknesses which are known security vulnerabilities that may exist within the system. For example, Cross Site Scripting (“CSS”). Weaknesses can also have inclusion rules.

The standard portion as shown in FIG. 3 can include non-technology-specific advice on how to mitigate particular weaknesses from a particular phase of the SDLC. For example, in code web-based output to avoid Cross Site Scripting. The standard sections may also have inclusion rules.

The implementation 56 relate to technology-specific advice that relates to particular standards. For example, particular advice on how to use the Microsoft Anti-XSS library to mitigate Cross Site Scripting for ASB.NET. Implementations may also feature attachments such as code samples.

The system also includes activities where a particular activity that a user can specify has been completed. Activities may be associated with standards. For example, a user can specify that they have completed the activity of including web-based output to avoid Cross Site Scripting.

Moreover, the system also includes tasks which can be a sub category of activity that provides more detail as to how a particular activity was completed. Tasks may be associated with implementations. For example, a user can specify that they have completed the task of using Microsoft Anti-XSS to mitigate Cross Site Scripting for ASB.NET. This in turn will show that they have completed the corresponding activity such as using web-based output to avoid Cross Site Scripting.

Furthermore, a checklist may be included as a logical grouping of activities and tasks. For example, a checklist of secure coding standards.

### Other Capabilities of the System

The system described herein can incorporate Static analysis tools to dynamically generate rules for Static Analysis rules for products like Fortify to create only relevant static analysis rules depending on the language, framework, and platform selected.

Moreover Runtime security testing tools can be incorporated to generate rules for runtime testing (similar to static analysis). Also the system can integrate the tool's capabilities in QA testing so that if somebody is using WebInspect, for example, they will get standards on how to test a particular weakness with WebInspect (or alternatively to notify a user if it's done automatically)

Bug tracking tools are a feature of the invention; and can export development standards as enhancement tickets into bug tracking systems so that developers can keep track of them there

QA testing toolscan be exported that include testing standards as test cases into QA testing systems so that QA staff can keep track automatically run scripts, keep track of test coverage and pass rate

The system described herein can export Requirements tracking tools into requirements systems so that requirements analysts can centrally store their security requirements

SDLC management tools can be utilized in related to the last three, except that some systems encompass all three and they can be considered SDLC management (e.g. HP Application Lifecycle management)

Governance, Risk, and Compliance tools can be integrated into Archer

The system includes monitor enterprise-wide compliance for application security relevant legislation/regulation. In particular Dashboard views that shows compliance status to PCI DSS, NERC CIP, GLBA, for all applications etc.

The system monitors enterprise-wide completion status of checklists, with dashboard views of how complete each project is

The system includes Risk ranking of application based on inherent risk of technology stack A risk number is assigned to a project.

Moreover the invention includes risk ranking of an application based on implementations of compensating controls This is similar to the previous paragraph, except a secondary rating that describes the reduction of risk once compensating controls are in place

### Method

Accordingly, the invention described herein relates to a method of providing security guidance in writing software applications.

The method includes activating a guidance application 12 linked to a computer 6 and a data base 14. The guidance application 12 being operable to present a user suggestive security content so that the user can write software applications in a more secure manner.

The guidance application 12 includes a communication facility 13 to provide an input to the guidance application 12 so as to generate suggestive instructions defining rules 16 to incorporate secure features in writing software applications.

The invention described herein also relates to a non-transitory computer program for use on a computer 6 where the non-transitory computer program includes a computer usable medium, and a computer readable program code recorded or storable in the computer usable medium, the computer readable program code defining a security guidance application 12 that is operable to:
(a) present to a user a suggestive modelling interface, a suggestive modelling interface operable to assist a user in producing software applications based on at lease one or more of the following:
   (i) writing software input from the user;
   (ii) one or more aspects of one or more suggestive security content obtained from a data base 14.

The suggestive modelling interface utilizes a matching operator 15 linked to the suggestive modelling interface 13 to dynamically and iteratively provide access to one or more security features from the data base 14 to provide suggestions to the user to write secure software applications.

The invention described herein also relates to a system for collecting data from a user's electronic device for via the internet to generate security guidance to a user in writing software applications which comprises the web server 6, the web server including a processor 8, and memory 10, operatively connected to the processor. A web application 12 is loaded on the web server 6. The data base 14 includes security features 16.

A data base management utility 16 is linked to the data base 14 and is responsive to the web application 12. The web application 12:
1. permits an authorized user to link to the web application through the electronic device 4
2. enter data relating to building the user software application
3. automatically generates suggestive security features stored in the data base.

The invention described herein provided tailored security advice to users, such as secure programming standards tailored to the programming language and technologies that the application is using. The method and system solicits the user's input to generate an understanding of potential security vulnerabilities and corresponding guidance.

No other computer program product provides tailored, secure requirements, programming, and quality assurance standards for a variety of technologies.

The invention described herein:
1. Generates tailored relevant security requirements for a particular project and industry.
2. Generates tailored relevant test cases and sample quality assurance test code.
3. Provides tracking and an audit trial for performing software security activities.
4. Provides continuously updated advice for all phases of the SDLC integrating changes to technology and accounting for newly discovered vulnerabilities.
5. Effectively solicits user's feedback and works with incomplete user feedback.
6. Grows the repository of knowledge.
7. Allows for multiple users to update the system concurrently and provide the ability to freeze changing of the project properties.
8. Effectively matches answers to questions with standards and implementations.

It will be appreciated by those skilled in the art that other variations of the preferred embodiment may also be practiced without departing from the scope of the invention.

We claim:

1. A method of providing security guidance in writing software applications.

2. A method as claimed in claim 1 including activating a guidance application linked to a computer and a database of security features, the guidance application being operable to present a user suggestive security content in writing software applications.

3. A method as claimed in claim 2 wherein the guidance application includes a communication facility providing an input to the guidance application to generate suggestive instructions defining rules to incorporate security features in writing software applications.

4. A method as claimed in claim 3 wherein said rules comprise software development life cycle (SDLC).

5. A method as claimed in claim 4 wherein said guidance application instructions incorporate security suggestions into the requirements, design, development, testing and deployment phase in the SDLC.

6. A method as claimed in claim 5 wherein said computer comprises a web server connected to the Internet, the web server incorporating a processor and memory operatively connected to the processor, the web server further including said guidance application.

7. A method as claimed in claim 6 including an electronic device to link to the web server through the Internet so as to link to the web server and receive suggestive security content on the electronic device of the user to incorporate when the user writes software applications.

8. A method as claimed in claim 7 wherein said suggestive content is automatically generated.

9. A method as claimed in claim 8 wherein said suggestive content is automatically tailored for the user writing software application.

10. A non-transitory computer program for use on a computer, the non-transitory computer product comprising:
a) a computer usable medium; and
b) computer readable program code recorded or storable in the computer usable medium, the computer readable program code defining a guidance application that is operable to;
i) present to a user a suggestive modeling interface, the suggestive modeling interface operable to assist a user in producing software applications based on at least one of the following:
A) writing software application input from the user;
B) one or more aspects of one or more suggestive security content obtained from a database;
ii) utilizing a matching operator linked to the suggestive modeling interface to dynamically and iteratively provide access to one or more security features from the database to permit the user to write software applications in a more secure manner.

11. A system for collecting data from a user's electronic device via the Internet to generate security guidance to the user in writing software applications comprising:
a) a web server connected to the Internet, the web server including a processor and a memory operatively connected to the processor;
b) a web application loaded on the web server;
c) a database of security features;
d) a database management utility linked to the database and responsive to the web application;
e) whereby the web application:
i) permits an authorized user to link to the web application through said electronic device;
ii) enter data relating to building the user software application;
iii) automatically generating suggestive security features stored in the database in response to the data relating to building the users software application.

12. A system as claimed in claim 11 wherein said web application generates security features during the entire process of a user writing software application.

13. A system as claimed in claim 12 wherein the web application automatically and iteratively generates security suggestive content during the requirement, design, development, testing and deployment phases of software development life cycle.

14. A system as claimed in claim 13 wherein said web application includes technical guidance on avoiding writing insecure software code from the beginning.

15. A system as claimed in claim 14 wherein the database includes rules relating to weakness, standards, implementation and rules to build a customizable set of guidance.

16. A system as claimed in claim 15 wherein said system includes videos on how to perform runtime testing.

17. A system as claimed in claim 16 wherein said database includes working code projects that users can import into their development projects.
